(19) United States
(12) Patent Application Publication
(10) Pub. No.: US 2005/0174361 A1
(43) Pub. Date: Aug. 11, 2005

(54) Image processing method and apparatus

(75) Inventors: Toshihiro Kobayashi, Kanagawa (JP); Toshikazu Ohshima, Kanagawa (JP); Masahiro Suzuki, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/044,555

(22) Filed: Jan. 28, 2005

(30) Foreign Application Priority Data
Feb. 10, 2004 (JP) 2004-033728

(51) Int. Cl. G06K 9/00

(52) U.S. Cl. 345/633

(57) ABSTRACT

In step S1030, the position and orientation of a stylus operated by the user on the physical space are calculated, and it is detected if the stylus is located on the surface of a real object on the physical space. In step S1040, a virtual index is laid out at the position on the virtual space, which corresponds to the position calculated upon detection. In step S1060, an image of the virtual space including the laid-out virtual index is superimposed on the physical space.

### FIELD OF THE INVENTION

The present invention relates to a technique for superimposing an image of a virtual space on a physical space.

### BACKGROUND OF THE INVENTION

Apparatuses that adopt a mixed reality (MR) technique which can naturally combine the real and virtual worlds have been extensively proposed. These MR presentation apparatuses combine an image on the physical space sensed by an imaging device such as a camera or the like to an image on the virtual space rendered by computer graphics (CG) and display the composite image on a display device such as a head-mounted display (HMD) or the like, thus presenting an MR space that merges the real and virtual spaces to the user of the MR apparatus.

In recent years, along with the advance of three-dimensional (3D) CAD (Computer Aided Design) and rapid prototyping technique, a mockup of a real object can be automatically generated from shape model data created by CAD on the computer within a relatively short period of time.

A mockup of a real object created by a rapid prototyping modeling machine (to be referred to as a real model hereinafter) has the same shape as that of a shape model created by CAD (to be referred to as a virtual model hereinafter), but the quality of its material is limited to those used in modeling. For this reason, the real model does not reflect any characteristics of the virtual model such as color, texture, pattern, and the like. Hence, a source virtual model used to create the real model is rendered by CG, and is superimposed on the real model to present it to the user using the MR apparatus, thus reflecting the characteristics of the virtual model such as color, texture, pattern, and the like on the real model.

Such MR apparatus is required to display the virtual model on the virtual space to accurately match the real model present in the physical space. In this case, since the real model is created from the virtual model created by CAD, they have the same shape and size. However, in order to match the two models on the MR space, the position and orientation in the physical space where the real object is present, and those in the virtual space where the virtual model is located must be accurately matched in addition to accurate matching between the real and virtual spaces. More specifically, the coordinate systems of the real and virtual spaces must be completely matched, and the coordinate positions of the real and virtual models must then be matched.

As for the former matching, many efforts have been conventionally made, and methods described in Japanese Patent Laid-Open Nos. 2002-229730, 2003-269913, and the like can implement alignment that accurately matches the real and virtual spaces.

As for the latter matching, conventionally, the position and orientation of the real model are measured by an arbitrary method, and the measured values are set for those of the virtual model.

As a method of measuring the position and orientation of the real model, a method using a measuring device such as a 3D position/orientation sensor, and a method of attaching a plurality of markers whose 3D positions are known to the real object, extracting these markers from an image obtained by sensing the real object by an imaging device such as a camera or the like by an image process, and calculating the position and orientation of the real model based on the correspondence between the image coordinate positions from which the markers are extracted, and the 3D positions are known.

However, in either method, it is difficult to strictly match the real and virtual models by merely applying the measured position and orientation of the real model. In the method using the measuring device, the position of a point on the real model, which corresponds to one point on the surface of the virtual model, must be accurately measured. However, it is difficult to find the point of the real model, which corresponds to the point on the virtual model.

In the method using the image process, markers that can be extracted by the image process must be prepared, and the 3D positions of the attached markers must be accurately measured. The precision of each 3D position significantly influences the precision of the position and orientation to be finally calculated. Also, the extraction precision of the markers largely depends on the illumination environment and the like.

When it is impossible to set a sensor on the real model or to attach markers, it is nearly impossible to accurately measure the position and orientation of the real model.

When it is difficult to directly measure the position and orientation of the real model, a method of specifying the position and orientation of the virtual model in advance and setting the real model at that position and orientation is adopted. However, with this method, the position and orientation of the set real model often suffer errors. For this reason, after the real model is roughly laid out, the position and orientation of the virtual model may be finely adjusted to finally match the real and virtual models.

However, in a general MR system, an image of the virtual space is superimposed on that of the physical space. For this reason, the user of that system observes as if the virtual model is always present in front of the real model, and it is difficult to recognize the positional relationship between the real and virtual models. Especially, in order to finely adjust the position and orientation of the virtual model, the accurate positional relationship between the two models must be recognized, and this poses a serious problem.

### SUMMARY OF THE INVENTION

The present invention has been made in consideration of the aforementioned problems, and has as its object to provide a technique for accurately matching real and virtual models having the same shape and size in an MR apparatus.

In order to achieve an object of the present invention, for example, an information processing method of the present invention comprises the following arrangement.

That is, an information processing method for generating an image by combining a virtual image and a physical space image, characterized by comprising:
a designation portion position acquisition step of acquiring a position of a designation portion operated by the user;
a user position/orientation acquisition step of acquiring a position and orientation of the user;
a detection step of detecting if the designation portion is located on a surface of a real object on a physical space;
a virtual index generation step of acquiring the position of the designation portion in response to the detection, and generating a virtual index on the basis of the position of the designation portion;
a virtual image generation step of generating an image of a virtual object corresponding to the real object from virtual space data on the basis of the position and orientation of the user; and
an adjustment step of adjusting the position and orientation of the virtual object in accordance with a user's instruction.

In order to achieve an object of the present invention, for example, an information processing method of the present invention comprises the following arrangement.

That is, an information processing method for generating an image by combine a virtual image and a physical space image, characterized by comprising:
a designation portion position acquisition step of acquiring a position of a designation portion operated by the user;
a user position/orientation acquisition step of acquiring a position and orientation of the user;
a detection step of detecting if the designation portion is located on a surface of a real object on a physical space;
an adjustment step of acquiring the position of the designation portion in response to the detection, and adjusting a position and orientation of the virtual object on the basis of the position of the designation portion; and
a virtual image generation step of generating an image of a virtual object corresponding to the real object from virtual space data on the basis of the adjusted position/orientation and the position/orientation of the user.

In order to achieve an object of the present invention, for example, an information processing apparatus of the present invention comprises the following arrangement.

That is, an information processing apparatus for generating an image by combining a virtual image and a physical space image, characterized by comprising:
designation portion position acquisition unit configure to acquire a position of a designation portion operated by the user;
user position/orientation acquisition unit configure to acquire a position and orientation of the user;
detection unit configure to detect if the designation portion is located on a surface of a real object on a virtual space;
virtual index generation unit configure to acquire the position of the designation portion in response to the detection, and generating a virtual index on the basis of the position of the designation portion;
virtual image generation unit configure to generate an image of a virtual object corresponding to a real object from virtual space data on the basis of the position and orientation of the user; and
adjustment unit configure to adjust the position and orientation of the virtual object in accordance with a user's instruction.

In order to achieve an object of the present invention, for example, an information processing apparatus of the present invention comprises the following arrangement.

That is, an information processing apparatus for generating an image by combining a virtual image and a physical space image, characterized by comprising:
designation portion position acquisition unit configure to acquire a position of a designation portion operated by the user;
user position/orientation acquisition unit configure to acquire a position and orientation of the user;
detection unit configure to detect if the designation portion is located on a surface of a real object on a physical space;
adjustment unit configure to acquire the position of the designation portion in response to the detection, and adjusting a position and orientation of a virtual object on the basis of the position of the designation portion; and
virtual image generation unit configure to generate an image of a virtual object corresponding to a real object from virtual space data on the basis of the adjusted position and orientation and the position and orientation of the user.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the basic arrangement of an MR presentation system according to the first embodiment of the present invention;

FIG. 2 shows the shape and structure of a stylus 302;

FIG. 3 shows a state wherein the user touches the surface of a real model with the stylus 302;

FIG. 4 shows a virtual model 402 obtained by modeling a real model 401 together with the real model 401;

FIG. 5 shows an example of an MR space image displayed on a display device 201;

FIG. 6 shows a display example of a window when a marker is displayed on the window shown in FIG. 5;

FIG. 7 shows an MR space image when many markers 404 are laid out;

FIG. 8 is a flowchart of the process for generating and displaying an MR space image, which is executed by the system according to the first embodiment of the present invention;

FIG. 9 shows a state wherein the virtual model 402 is moved along an axis A;

FIG. 10 shows a state wherein an asterisk on the right side surface of the real model 401 is defined as a point P, and the virtual model 402 is moved to the right;

FIG. 11 shows the result after the virtual model 402 is moved to the right;

FIG. 12 shows a state wherein an asterisk on the top surface of the real model 401 is defined as a point P, and the virtual model 402 is moved downward;

FIG. 13 shows the result after the virtual model 402 is moved downward and the position of the virtual model 402 matches that of the real model 401;

FIG. 14 shows a state wherein an asterisk on the right side surface of the real model 401 is defined as a point P, an asterisk on the lower right vertex of the real model 401 is defined as a point Q, and the virtual model 402 is rotated about the point Q as a fulcrum; and

FIG. 15 shows a processing part for changing the position and orientation of the virtual model 402 and matching the virtual model 402 with the real model 401, which is extracted from the flowchart of the process for generating and displaying an MR space image, that is executed by the system according to the fourth embodiment of the present invention.

### DETAILED DESCRIPTION OF THE PREFERRED EMBODIMENTS

Preferred embodiments of the present invention will now be described in detail in accordance with the accompanying drawings.

### First Embodiment

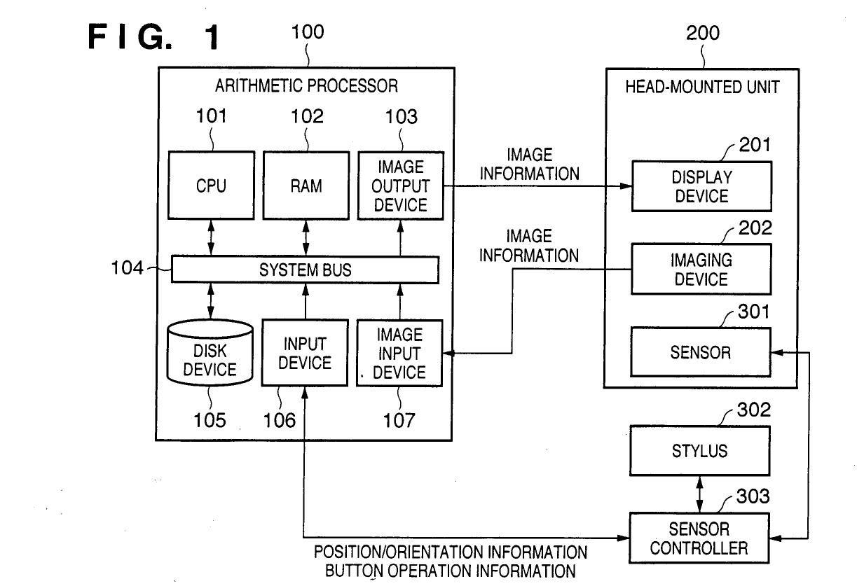

FIG. 1 is a block diagram showing the basic arrangement of an MR presentation system according to this embodiment.

Referring to FIG. 1, an arithmetic processor 100 comprises a computer such as a PC (personal computer), WS (workstation), or the like. The arithmetic processor 100 includes a CPU 101, RAM 102, image output device 103, system bus 104, disk device 105, input device 106, and image input device 107.

The CPU 101 controls the overall arithmetic processor 100 and performs various processes for generating and presenting an image of the MR space using programs and data loaded on the RAM 102. The CPU 101 is connected to the system bus 104, and can communicate with the RAM 102, image output device 103, disk device 105, input device 106, and image input device 107 in two ways.

The RAM 102 is implemented by a main storage device such as a memory or the like. The RAM 102 has an area for storing programs, data, and control information of the programs loaded from the disk device 105, image data of the physical space input from the image input device 107, and the like, and also a work area required when the CPU 101 executes various processes.

Data input to the RAM 102 include, e.g., a virtual object (CG model) on the virtual space, virtual space data associated with its layout and the like, sensor measured values, sensor calibration data, and the like. The virtual space data include data associated with images of a virtual object and virtual index (to be described later) to be laid out on the virtual space, data associated with their layouts, and the like.

The image output device 103 is implemented by a device such as a graphics card or the like. In general, the image output device 103 holds a graphics memory (not shown). Image information generated by executing a program by the CPU 101 is written in the graphics memory held by the image output device 103 via the system bus 104. The image output device 103 converts the image information written in the graphics memory into an appropriate image signal, and outputs the converted information to a display device 201. The graphics memory need not always be held by the image output device 103, and the graphics memory function may be implemented by some area in the RAM 102.

The system bus 104 is a communication path to which the respective devices that form the arithmetic processor 100 are connected to communicate with each other.

The disk device 105 is implemented by an auxiliary storage device such as a hard disk or the like. The disk device 105 holds programs and data, control information of the programs, virtual space data, sensor calibration data, and the like, which are required to make the CPU 101 execute various processes, and are loaded as needed onto the RAM 102 under the control of the CPU 101.

The input device 106 is implemented by various interface devices. That is, the input device 106 receives signals from devices connected to the arithmetic processor 100 as data, and inputs them to the CPU 101 and RAM 102 via the system bus 104. The input device 106 comprises devices such as a keyboard, mouse, and the like, and accepts various instructions from the user to the CPU 101.

The image input device 107 is implemented by a device such as a capture card or the like. That is, the image input device 107 receives an image of the physical space output from an imaging device 202, and writes image data on the RAM 102 via the system bus 104. When a head-mounted unit 200 (to be described later) is of optical see-through type (it does not comprise any imaging device 202), the image input device 107 may be omitted.

The head-mounted unit 200 is a so-called HMD main body, and is to be mounted on the head of the user who experiences the MR space. The head-mounted unit 200 is mounted, so that the display device 201 is located in front of the eyes of the user. The head-mounted unit 200 includes the display device 201, the imaging device 202, and a sensor 301. In this embodiment, the user wears a device which forms the head-mounted unit 200. However, the user need not always wear the head-mounted unit 200 as long as he or she can experience the MR space.

The display device 201 corresponds to a display equipped in a video see-through HMD, and displays an image according to an image signal output from the image output device 103. As described above, since the display device 201 is located in front of the eyes of the user who wears the head-mounted unit 200 on the head, an image can be presented to the user by displaying that image on the display device 201.

Note that another system for presenting an image to the user may be proposed. For example, a floor type display device may be connected to the arithmetic processor 100, and an image signal output from the image output device 103 may be output through, to this display device, thus presenting an image according to this image signal to the user.

The imaging device 202 is implemented by one or more imaging devices such as CCD cameras and the like. The imaging device 202 is used to sense an image of the physical space viewed from the user's viewpoint (e.g., eyes). For this purpose, the imaging device 202 is preferably mounted at a position near the user's viewpoint position, but its location is not particularly limited as long as it can capture an image viewed from the user's viewpoint. The image of the physical space sensed by the imaging device 202 is output to the image input device 107 as an image signal. When an optical see-through display device is used as the display device 201, since the user directly observes the physical space transmitted through the display device 201, the imaging device 202 may be omitted.

The sensor 301 serves as a position/orientation measuring device having six degrees of freedom, and is used to measure the position and orientation of the user's viewpoint. The sensor 301 performs a measurement process under the control of a sensor controller 303. The sensor 301 outputs the measurement result to the sensor controller 303 as a signal. The sensor controller 303 converts the measurement result into numerical value data on the basis of the received signal, and outputs them to the input device 106 of the arithmetic processor 100.

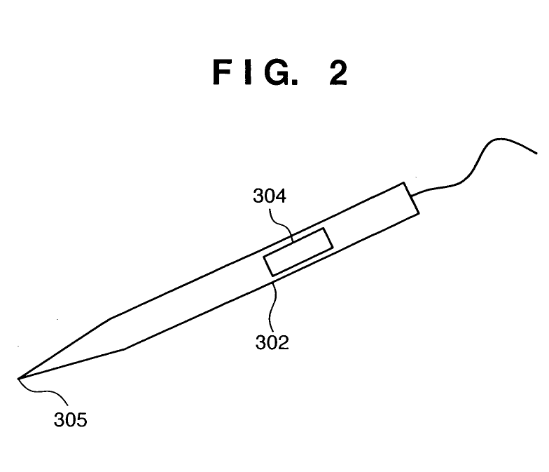

A stylus 302 is a sensor having a pen-like shape, and is used while the user holds it in his or her hand. FIG. 2 shows the shape and structure of the stylus 302. The stylus 302 measures the position and orientation of a tip portion 305 under the control of the sensor controller 303, and outputs its measurement result to the sensor controller 303 as a signal. In the following description, the position and orientation of the tip portion 305 will be referred to as those of the stylus 302.

At least one push-button switch 304 is attached to the stylus 302. Upon depression of the push-button switch 304, a signal indicating the depression is output to the sensor controller 303. When the stylus 302 has a plurality of switches 304, a signal indicating which button is pressed is output from the stylus 302 to the sensor controller 303.

The sensor controller 303 outputs control commands to the sensor 301 and stylus 302, and acquires the measurement values of the positions and orientations and information associated with depression of the push-button switch 304 from the sensor 301 and stylus 302. The sensor controller 303 outputs the acquired information to the input device 106.

In this embodiment, the user who wears the head-mounted unit 200 holds the stylus 302 with his or her hand, and touches the surface of the real model with the stylus 302. Note that the real model is an object present on the physical space.

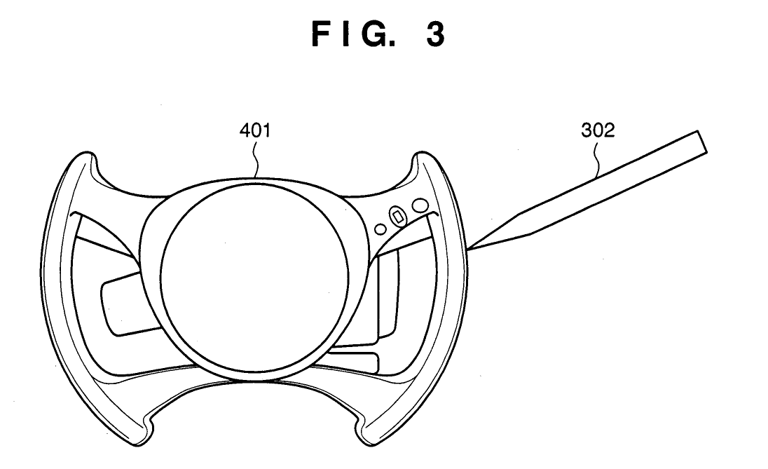

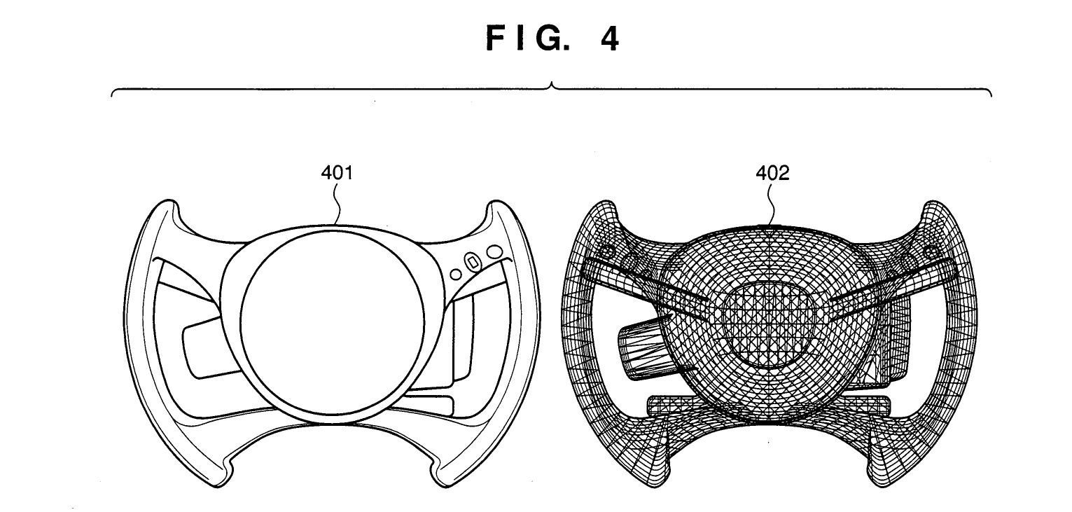

FIG. 3 shows a state wherein the surface of the real model is touched with the stylus 302. The shape of a real model 401 has already been modeled, and a virtual model having the same shape and size as the real model 401 is obtained. FIG. 4 shows a virtual model 402 obtained by modeling the real model 401, along with the real model 401.

As a method of preparing the real model 401 and virtual model 402 having the same shape and size, for example, after the virtual model 402 is modeled by a CAD tool or the like, the real model 401 is created from the virtual model 402 using, e.g., a rapid prototyping modeling machine. Also, in another method, the existing real model 401 is measured by a 3D object modeling device, and the virtual model 402 is created from the real model 401.

In either method, such virtual model data is saved on the disk device 105 while being included in the virtual space data, and is loaded onto the RAM 102 as needed.

The basic operation of the system according to this embodiment with the above arrangement will be described below. Before the beginning of the following processes, the real and virtual spaces must be matched. For this purpose, calibration must be made before launching the system to obtain sensor calibration information. The sensor calibration information to be obtained includes 3D coordinate conversion between the real and virtual space coordinate systems, and that between the position and orientation of the user's viewpoint and those to be measured by the sensor 301. Such calibration information is obtained in advance, and is stored in the RAM 102.

Note that Japanese Patent Laid-Open Nos. 2002-229730 and 2003-269913 explain the method of calculating these conversion parameters and making sensor calibration. In this embodiment as well, the position/orientation information obtained from the sensor 301 is converted into that of the user's viewpoint, and the position/orientation information on the virtual space is converted into that on the physical space using the calibration information as in the prior art.

After the system is launched, the imaging device 202 senses a moving image of the physical space, and frame data that form the sensed moving image are input to the RAM 102 via the image input device 107 of the arithmetic processor 100.

On the other hand, since the result measured by the sensor 301 is input to the RAM 102 via the input device 107 of the arithmetic processor 100 under the control of the sensor controller 303, the CPU 101 calculates the position and orientation of the user's viewpoint from this result by known calculations using the calibration information, and generates an image of the virtual space viewed according to the calculated position and orientation of the user's viewpoint by a known technique. Note that the data required to render the virtual space has already been loaded onto the RAM 102, and is used upon generating the image of the virtual space. Since the process for generating an image of the virtual space viewed from a predetermined viewpoint is a known technique, a description thereof will be omitted.

The image of the virtual space generated by such process is rendered on the image of the physical space previously input to the RAM 102. As a result, an image (MR space image) obtained by superimposing the image of the virtual space on that of the physical space is generated on the RAM 102.

The CPU 101 outputs this MR space image to the display device 201 of the head-mounted unit 200 via the image output device 103. As a result, since the MR space image is displayed in front of the eyes of the user who wears the head-mounted unit 200 on the head, this user can experience the MR space.

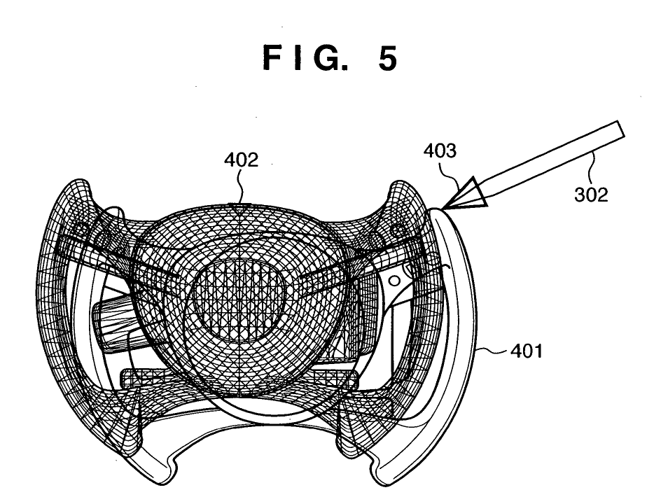

In this embodiment, the image of the physical space includes the real model 401 and stylus 302, and that of the virtual space includes the virtual model 402 and a stylus virtual index (to be described later). The MR space image obtained by superimposing the image of the virtual space on that of the physical space is displayed on the display device 201. FIG. 5 shows an example of the MR space image displayed on the display device 201.

In FIG. 5, a stylus virtual index 403 is a CG which is rendered to be superimposed at the position of the tip portion 305 of the stylus 302, and indicates the position and orientation of the tip portion 305. The position and orientation of the tip portion 305 are obtained by converting those measured by the stylus 302 using the calibration information. Therefore, the stylus virtual index 403 is laid out at the position measured by the stylus 302 to have the orientation measured by the stylus 302.

While the real and virtual spaces are accurately matched, the position of the tip portion 305 accurately matches that of the stylus virtual index 403. Hence, in order to lay out the stylus virtual index 403 at a position as close as possible to the tip portion 305, the real and virtual spaces must be matched, i.e., the calibration information must be calculated, as described above.

In a general MR system, since a CG is always displayed on the image of the physical space, the tip portion 305 cannot often be observed while being shielded by the virtual model 402. However, with the aforementioned process, the user can recognize the position of the tip portion 305 based on the stylus virtual index 403.

In FIG. 5, the stylus virtual index 403 has a triangular shape, but its shape is not particularly limited as long as it can express the position and orientation of the tip portion 305. For example, the positional relationship between the tip portion 305 and virtual model 402 can be easily recognized by outputting a virtual ray from the tip portion 305 in the axial direction of the stylus 302 using the orientation of the stylus 302. In this case, the virtual ray serves as the stylus virtual index 403.

The user presses the push-button switch 304 when the tip portion 305 of the stylus 302 in his or her hand touches the surface of the real model 401. When the user has pressed the push-button switch 304, a “signal indicating depression of the push-button switch 304” is output from the stylus 302 to the input device 107 via the sensor controller 303. Upon detection of this signal, the CPU 101 converts the position obtained from the stylus 302 at the time of detection into that on the virtual space using the calibration information, and lays out a virtual index as a marker at the converted position. In other words, this layout position corresponds to a position where the stylus virtual index 402 is laid out upon depression of the switch 304.

Note that the tip portion 305 of the stylus 302 may have a pressure sensor such as a piezoelectric element or the like. This pressure sensor may detect that the tip portion 305 has touched the surface of the real model 401, and may output a signal indicating this to the CPU 101 via the sensor controller 303. Upon reception of this signal, the CPU 101 may display the aforementioned marker. In this case, the push-button switch 304 may be omitted.

In this way, various means for informing the CPU 101 that the tip portion 305 has touched the surface of the real model 401 may be used, and the present invention is not limited to specific means.

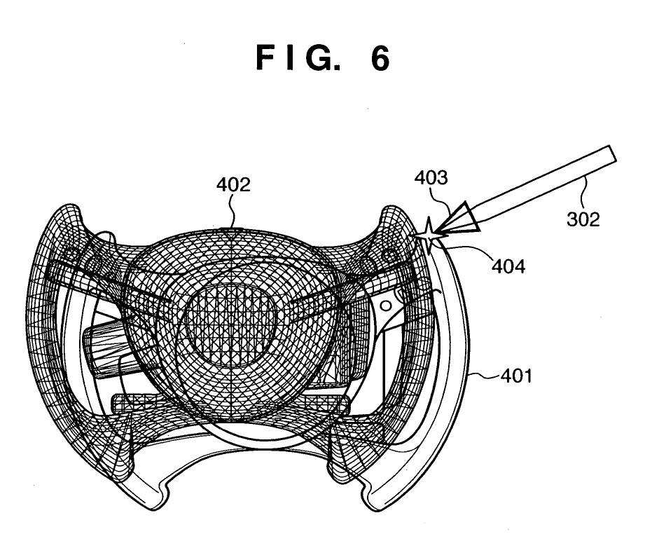

FIG. 6 shows a display example of a window when the marker is displayed on the window shown in FIG. 5. Since a marker 404 is displayed when the tip portion 305 has touched the surface of the real model 401, it is always present on the surface of the real model 401. That is, the marker 404 indicates the position of the surface of the real model 401 on the virtual space. By setting many markers 404 at appropriate intervals, the shape of the real model 401 on the virtual space can be recognized.

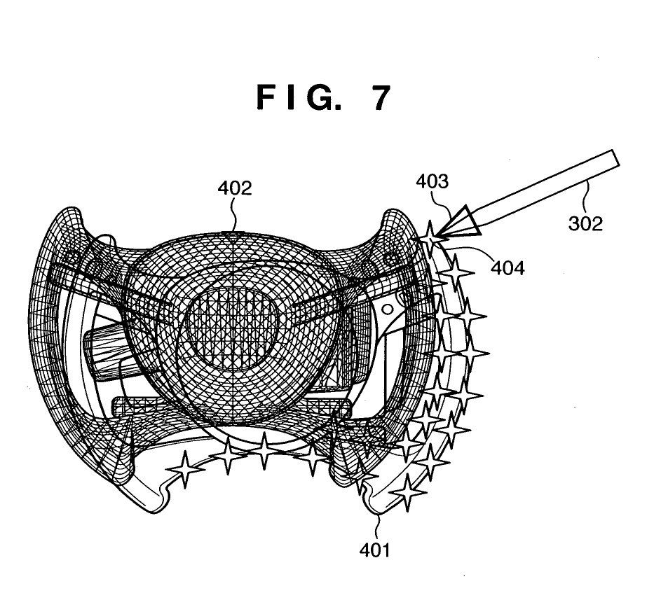

FIG. 7 shows the MR space image when many markers 404 are laid out.

With the above process, the marker is displayed at the position on the virtual space corresponding to the surface position of the real model 401 touched with the stylus 302. Since this marker is a virtual object, it can be presented to the user without being occluded by a real object.

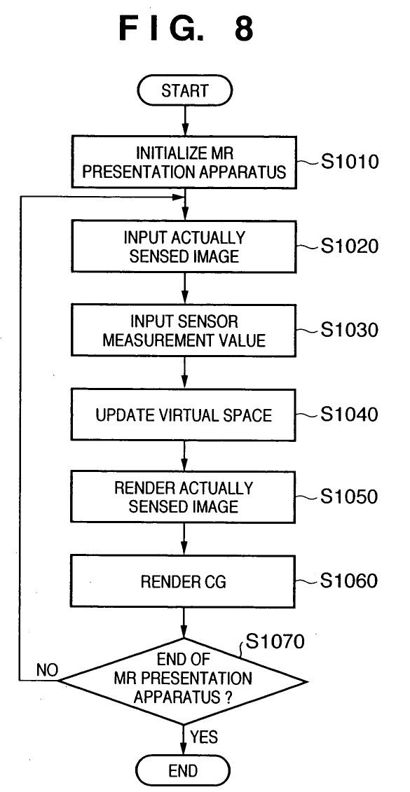

FIG. 8 is a flowchart of the process for generating and displaying an MR space image, which is executed by the aforementioned system of this embodiment. Note that a program according to the flowchart of FIG. 8 is saved in the disk device 105, and is loaded onto the RAM 102 under the control of the CPU 101. When the CPU 101 executes this program, the arithmetic processor 100 according to this embodiment executes various processes to be described below.

In step S1010, initialization required to launch the system is done. The required initialization includes initialization processes of devices connected, and processes for reading out a data group such as virtual space data, sensor calibration information, and the like used in the following processes from the disk device 105 onto the RAM 102.

Processes in steps S1020 to S1060 are a series of processes required to generate an MR space image, and will be called a frame together. When the processes for a frame are executed once, such processes will be called one frame. That is, execution of a series of processes in steps S1020 to S1060 will be called “one frame”. Note that the order of some processes in one frame may be changed as long as the following conditions are met.

That is, the process in step S1040 must be done after that in step S1030. The process in step S1050 must be done after that in step S1020. The process in step S1060 must be done after that in step S1050. The process in step S1060 must be done after that in step S1040.

In step S1020, the image input device 107 receives an image (actually sensed image) of the physical space sensed by the imaging device 202, and writes it on the RAM 102. The image of the physical space is that of the physical space seen from the user's viewpoint, as described above.

In step S1030, the input device 106 acquires the measurement values output from the sensor controller 303. The CPU 101 converts the acquired measurement values into the position and orientation of the user's viewpoint using the calibration information, and writes them on the RAM 102. Also, the CPU 101 acquires the measurement values of the stylus 302, converts them into an appropriate position and orientation using the calibration information, and writes them on the RAM 102.

Also, in step S1030, user's operation information is input to the input device 107, and is written on the RAM 102. The operation information in this case includes information indicating whether or not the push-button switch 304 of the stylus 302 has been pressed, and input information to input devices such as a keyboard, mouse, and the like of the input device 107.

Furthermore, in step S1030, the CPU 101 interprets the operation information. For example, prescribed functions such as “save data associated with the virtual space on the disk device 105”, “move the virtual model 402 0.1 in the positive X-axis direction”, and so forth are assigned in advance to specific keys on the keyboard. When the user has pressed the corresponding key, the CPU 101 interprets that the assigned function is executed in the subsequent process.

In step S1040, the virtual space is updated on the basis of the contents interpreted in step S1030. The update process of the virtual space includes the following processes.

If it is determined in step S1030 that the push-button switch 304 has been pressed, the CPU 101 lays out the marker 404 at a position on the virtual space, which is obtained by converting the position measured by the stylus 302 at that time using the calibration information. Obviously, the state of the virtual space held on the RAM 102 is updated by this process.

On the other hand, if it is determined in step S1030 that an operation corresponding to “change in position/orientation of the virtual mode 402” has been made, the CPU 101 changes the position/orientation data of the virtual model 402 included in the virtual space data in accordance with the change instruction. As a result, the state of the virtual space held on the RAM 102 is updated by this process.

Also, if it is determined in step S1030 that an operation corresponding to “save the virtual space” has been done, the CPU 101 outputs the virtual space data held on the RAM 102 to the disk device 105.

In this manner, in step S1040 the state of the virtual space is changed according to various kinds of information input in step S1030, and its data is saved. However, the update process in step S1040 is not based on such information. In addition, for example, when a virtual object on the virtual space dynamically changes its position and orientation (of course, a program to implement such process is loaded onto the RAM 102, and the CPU 101 executes this program), the state of the virtual space is updated.

The data associated with the virtual space updated in this way is temporarily stored in the RAM 102.

Referring back to FIG. 8, in step S1050 the CPU 101 reads out the image of the physical space written on the RAM 102 in step S1020, and outputs and stores it to (the graphics memory of) the image output device 103. When an optical see-through display device is used as the display device 201, the process in step S1050 may be skipped.

In step S1060, the CPU 101 renders the image of the virtual space seen according to the position and orientation of the user's viewpoint using the measurement values acquired in step S1030 and the virtual space data updated in step S1050 by a known technique. After rendering, the CPU 101 outputs the rendered image to (the graphics memory of) the image output device 103.

The rendered image of the virtual space includes the CG of the stylus virtual index 403 and the marker 404. Upon rendering the stylus virtual index 403, it is rendered on the virtual space image to have the position and orientation according to those of the tip portion 305.

The marker 404 is rendered in the same manner as that of other virtual objects. That is, an image of the marker, which is laid out on the virtual space and is seen at the position and orientation of the user's viewpoint, is rendered.

In this way, the image of the virtual space is output to the rendering memory (graphics memory) of the image output device 103. Since this rendering memory stores the image of the physical space previously in step S1050, the image of the virtual space is rendered on that of the physical space. Therefore, as a result, an image obtained by superimposing the image of the virtual space on the physical space, i.e., the image of the MR space, is generated on the rendering memory.

In step S1060, a process for outputting the image of the MR space generated on the rendering memory of the image output device 103 to the display device 201 of the head-mounted unit 200 is done under the control of the CPU 101. When an optical see-through display device is used as the display device 201, since the output process of the image of the physical space to the rendering memory of the image output device 103 is not performed in step S1050, the image output device 103 outputs only the image of the virtual space to the display device 201.

In this way, the display device 201 located in front of the eyes of the user displays the image of the virtual space superimposed on the physical space, and also the marker 404 at a position where the stylus 302 contact the real object on this image. Hence, the user can experience the MR space, and can confirm visual information associated with the real object such as the shape, size, and the like of the real object without occlusion by the real model 401.

The flow returns from step S1070 to step S1020 unless the CPU 101 detects that the end instruction of the processes in steps S1010 to S1060 is input from the input device 107, thus repeating the subsequent processes.

Normally, the processes for one frame are done within several msec to several hundreds msec. When the user makes an operation (e.g., he or she changes the position/orientation of his or her viewpoint, presses the push-button switch 304, changes the position/orientation of the virtual model 402, and so forth), that operation is executed instantly, and the execution result is reflected on the display device 201 in real time.

For this reason, upon determining the position and orientation of the virtual model 402, the user can repeat adjustment to make them approach those of the real model 401 while actually changing the position and orientation values of the virtual model 402 and confirming the change result.

One characteristics feature of this embodiment lies in that the marker 404 is displayed to make the user recognize the shape of the real model 401 without being occluded by the virtual model 402. Hence, the virtual model 402 is not displayed in some cases. In such case, upon finely adjusting the position/orientation of the virtual model 402, the user inputs an instruction to the CPU 101 via the input device 107 to display the virtual model 402.

### Second Embodiment

A system according to this embodiment has the same arrangement as that of the first embodiment, i.e., the arrangement shown in FIG. 1. However, as for the stylus 302, a pressure sensor such as a piezoelectric element or the like is provided to the tip portion 305 in addition to the switch 304 in this embodiment. That is, the stylus 302 according to this embodiment can inform the CPU 101 of a signal indicating whether or not the tip portion 305 contacts the surface of the real model 401.

In this embodiment, the user can adjust the virtual model 402 to match the real model 401 by changing the position and orientation of the virtual model 402 using the stylus 302. Note that the flowchart of the process to be executed by the CPU 101 of the arithmetic processor 100 according to this embodiment follows that shown in FIG. 8. However, unlike in the first embodiment, when the tip portion 305 of the stylus 302 touches the surface of the real model 401 (when the stylus 302 (more specifically, the pressure sensor) outputs a signal indicating that the tip portion 305 has touched the surface of the real model 401 to the CPU 101, and the CPU 101 detects that signal), and when the user presses the push-button switch 304, the following processes are done in step S1040.

A surface which has a minimum distance to the position of the tip portion 305 is selected from those which form the virtual model 402 with reference to the position of the tip portion 305 of the stylus 302 acquired in step S1030 and the shape data of the virtual model 402. For example, when the virtual model 402 is formed of surfaces such as polygons or the like, a polygon which has a minimum distance to the tip portion 305 can be selected. Note that the surface to be selected is not limited to a polygon, but may be an element with a predetermined size, which forms the virtual model 402.

In the following description, let P be a point that represents the tip portion 305, S be a surface which has a minimum distance to the tip portion 305, and d be the distance between P and S.

Next, the position of the virtual model 402 is moved along a specific axis A to make the distance d zero (in a direction to decrease the distance d). Assume that this axis A is a straight line having the orientation of the stylus 302 acquired in step S1030 as a direction vector.

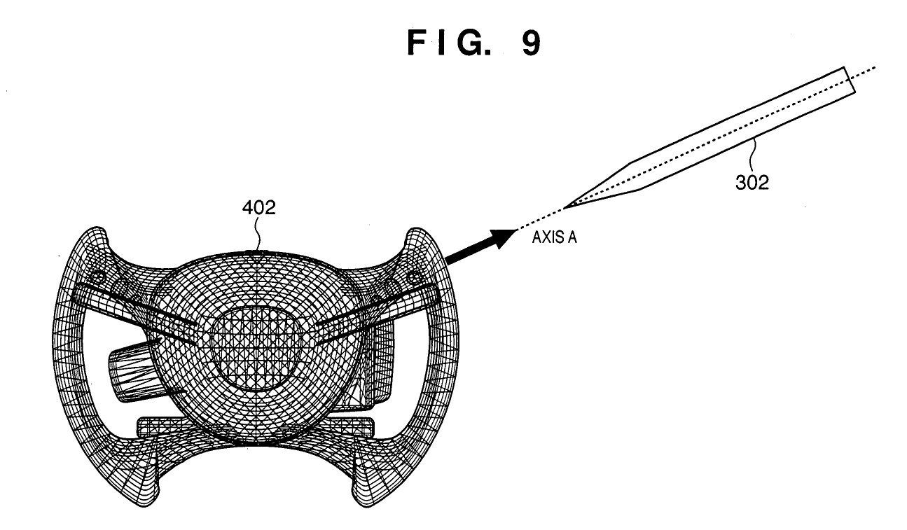

FIG. 9 shows a state wherein the virtual model 402 is moved along the axis A. In this embodiment, the direction of the stylus 302 is defined as the axis A. Alternatively, a normal to the surface S may be defined as the axis A. In this case, the normal to each surface which forms the virtual model 402 is included in data required to render the virtual model 402 in the virtual space data. Hence, the normal to the surface S can be acquired with reference to this data.

With the above process, when the user presses the switch 304 while the tip portion 305 of the stylus 302 contacts the surface of the real object 401, the virtual model 402 moves along the axis A and contacts the real model 401 at the point P.

When the position of the virtual model 402 does not match the real model 401 by this process, the user touches another point P with the stylus 302, and presses the push-button switch 304. In this way, when the user specifies the points P in a plurality of frames to repeat similar processes, the position of the virtual model 402 can be brought closer to that of the real model 401.

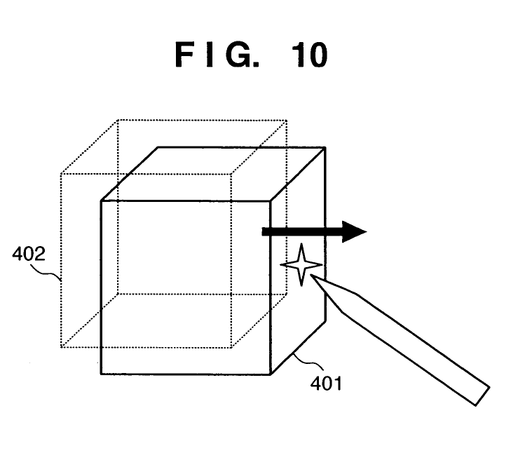

FIGS. 10 to 13 show a state wherein the position of the virtual model 402 is brought closer to the real model 401. In FIGS. 10 to 13, a cube indicated by the solid line is the real model 401, and a cube indicated by the dotted line is the virtual model 402. An asterisk in FIGS. 10 to 13 indicates the point P.

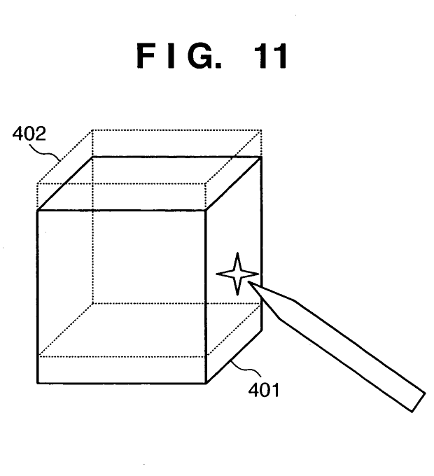

FIG. 10 shows a state wherein an asterisk on the right side surface of the real model 401 is defined as the point P, and the virtual model 402 is moved to the right. FIG. 11 shows the result after the virtual mode 402 is moved to the right.

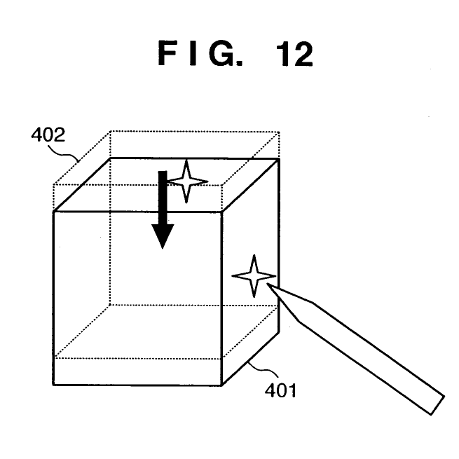

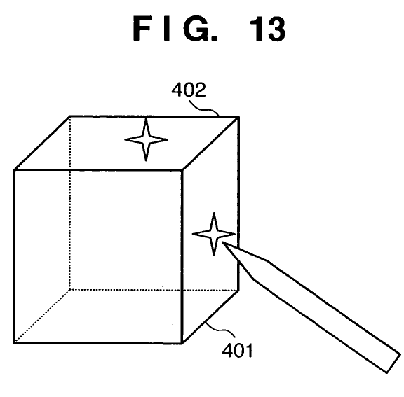

FIG. 12 shows a state wherein an asterisk on the top surface of the real model 401 is defined as the point P, and the virtual model 402 is moved downward. FIG. 13 shows the result after the virtual model 402 is moved downward, and the position of the virtual model 402 matches the real model 401.

Also, in this embodiment, the orientation of the virtual model can be manually adjusted on the basis of that of the stylus.

When the user presses the push-button switch 304 while the tip portion 305 of the stylus 302 does not touch the surface of the real model 401, the difference between the current orientation of the tip portion 305 of the stylus and that in the immediately preceding frame is calculated, and that difference is added to the orientation of the virtual model 402, thus changing the orientation.

In this way, when the user changes the orientation of the stylus 302 by holding down the push-button switch 304 while the tip portion 305 of the stylus 302 does not touch the surface of the real model 401, the orientation of the virtual model 402 can be changed. When the user releases the push-button switch 304, the orientation of the virtual model 402 is fixed to that upon releasing the push-button switch 304.

According to this embodiment, when the user presses the push-button switch 304 while the tip portion 305 of the stylus 302 touches the surface of the real model 401, the position and orientation of the virtual model 402 can be adjusted on the basis of those of the virtual model and stylus.

When the user presses the push-button switch 304 and changes the orientation of the stylus 302 while the tip portion 305 of the stylus 302 does not touch the surface of the real model 401, the orientation of the virtual model 402 can be arbitrarily adjusted on the basis of that of the stylus.

### Third Embodiment

In this embodiment, the virtual model 402 is adjusted to match the real model 401 by changing the position and orientation of the virtual model 402 using a method different from the second embodiment. Note that a system according to this embodiment has the same arrangement as that of the second embodiment, and the flowchart of the process to be executed by the CPU 101 of the arithmetic processor 100 according to this embodiment follows that shown in FIG. 8. However, unlike in the second embodiment, when the tip portion 305 of the stylus 302 touches the surface of the real model 401 (when the stylus 302 (more specifically, the pressure sensor) outputs a signal indicating that the tip portion 305 has touched the surface of the real model 401 to the CPU 101, and the CPU 101 detects that signal), and when the user presses the push-button switch 304, the following processes are done in step S1040.

A surface which has a minimum distance to the position of the tip portion 305 is selected from those which form the virtual model 402 with reference to the position of the tip portion 305 of the stylus 302 acquired in step S1030 and the shape data of the virtual model 402. For example, when the virtual model 402 is formed of surfaces such as polygons or the like, a polygon which has the minimum distance to the tip portion 305 can be selected. Note that the surface to be selected is not limited to a polygon, but may be an element with a predetermined size, which forms the virtual model 402.

In the following description, let P be a point that represents the tip portion 305, S be a surface which has a minimum distance to the tip portion 305, and d be the distance between P and S.

Next, the position of the virtual model 402 is rotated about a specific point Q as a fulcrum or a line segment that couples specific two points Q and R as an axis to make the distance d zero (in a direction to decrease the distance d). These specific points Q and R may be set when the user designates arbitrary points using the stylus 302 or points P set in the old frames may be set.

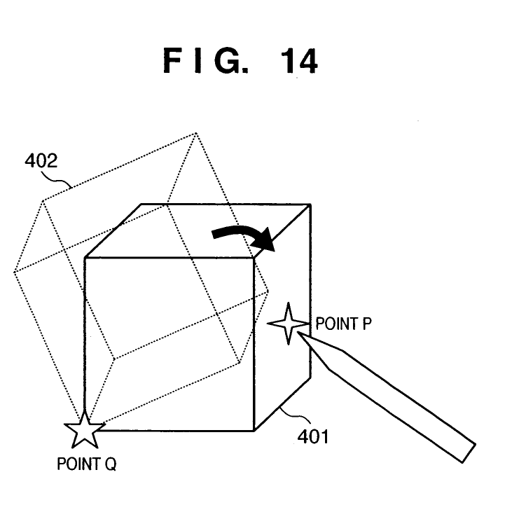

FIG. 14 shows a state wherein an asterisk on the right side surface of the real model 401 is defined as a point P, an asterisk on the lower right vertex of the real model 401 is defined as a point Q (the real model 401 and virtual model 402 match at this point), and the virtual model 402 is rotated about the point Q as a fulcrum.

Other processes are the same as those in the second embodiment.

### Fourth Embodiment

In this embodiment, the virtual model 402 is adjusted to match the real model 401 by changing the position and orientation of the virtual model 402 using a method different from the above embodiment. More specifically, the user associates a plurality of predetermined points (to be referred to as feature points) on the virtual model 402 with the corresponding points on the real model 401 by touching them using the stylus 302 in a predetermined order, thus automatically matching the virtual model 402 with the real model 401.

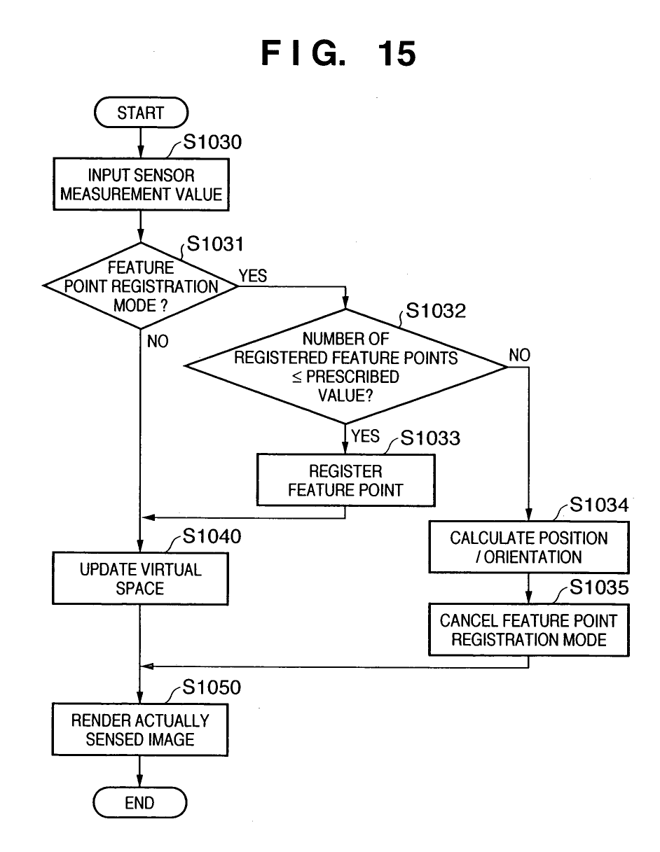

Note that a system according to this embodiment has the same arrangement as that of the second embodiment, and the flowchart of the process to be executed by the CPU 101 of the arithmetic processor 100 according to this embodiment is obtained by replacing the processes in steps S1030 to S1050 in the flowchart of FIG. 8 by that shown in FIG. 15.

FIG. 15 shows a processing part for changing the position and orientation of the virtual model 402 and matching the virtual model 402 with the real model 401, which is extracted from the flowchart of the process for generating and displaying an MR space image, that is executed by the system according to this embodiment.

Prior to launching the system, four or more feature points are set on the surface of the virtual model 402 upon creating the virtual model 402. Note that all feature points must not be present on a single plane. These points are associated with those on the real model 401 when the user touches corresponding feature points on the real model 401 using the stylus 302. For this reason, points which can be easily identified on the real model 401 such as corners of sides, projections, recesses, and the like are preferably selected.

The order of associating the feature points by the user is designated upon creating the virtual model 402. Data associated with these feature points are saved on the disk device 105. The data associated with each feature point includes a set of a 3D coordinate position of that feature point or a vertex ID of a polygon that forms the virtual model 402, and the order of association, and this set is described in correspondence with the number of feature points.

If the user makes an operation corresponding to “associate feature points” in step S1030, the feature point data registered so far are discarded, and the control enters a feature point registration mode.

If the control has entered the feature point registration mode in step S1031, the flow advances to step S1032; otherwise, the flow advances to step S1040.

In step S1032, the number of feature points registered so far is checked. If the number of feature points is smaller than a prescribed value, the flow advances to step S1033; otherwise, the flow advances to step S1034.

If the push-button switch 304 has been pressed in step S1030, the acquired position of the tip portion 305 is registered as a feature point in step S1033. The process for acquiring the position upon depression of the switch 304 is the same as in the above embodiment.

Also, the feature point registration process may be done when a pressure sensor such as a piezoelectric element or the like is provided to the tip portion 305, the push-button switch 304 is pressed while it is detected that the tip portion 305 touches the surface of the real model 401, and the CPU 101 detects this. If the push-button switch 304 has not been pressed, step S1033 is skipped, and the flow advances to step S1040.

In step S1034, the position and orientation of the virtual model 402 are calculated from the registered feature points. For example, the position and orientation of the virtual model 402 are calculated as follows.

Let Pₖ be a feature point defined on the virtual model 402, and pₖ=(Xₖ, Yₖ, Zₖ, 1)^{T} be its coordinate position. Also, let qₖ=(Xₖ, Yₖ, Zₖ, 1)^{T} be the measured values upon measuring the coordinate position of Pₖ by the tip portion 305. Let P=(p₁, p₂, . . . pₙ) be a matrix formed by arranging pₖ in correspondence with the number of feature points (where n is the number of feature points; n≧4). Likewise, Q=(q₁, q₂, . . . , qₙ).

At this time, the relationship between P and Q can be described as Q=MP (where M is a 4×4 matrix), and represents 3D coordinate conversion that converts a point pₖ to qₖ. That is, by applying the conversion given by M to the virtual model 402, it can be matched with the real model 401. This M can be given by:
M=Q(P^{T}P)⁻¹P^{T}
where (P^{T}P)⁻¹ is the pseudo inverse matrix of P.

In step S1035, the feature point registration mode is canceled, and the flow advances to step S1050.

### Fifth Embodiment

In the fifth embodiment, a mode that adjusts the position/orientation of the virtual model 402 and a mode that does not adjust the position/orientation of the virtual model 402 can be switched as needed. In this embodiment, the process according to the flowchart shown in FIG. 8 is done. However, if the user makes an operation corresponding to “shift to the position/orientation adjustment mode of the virtual model 402” in step S1030, the next process to be executed is the same as that in the first to fourth embodiments.

On the other hand, if the user makes an operation corresponding to “shift to the non-position/orientation adjustment mode of the virtual model 402” in step S1030, no marker 404 is registered even when the push-button switch 304 is pressed in step S1040. Furthermore, in step S1060, neither the stylus virtual index 403 nor the marker 404 are rendered. Also, the processes in the second to fourth embodiments are skipped.

That is, in this embodiment, a normal MR process and an adjustment process of the virtual model 402 can be selectively used in a single MR presentation apparatus.

### Other Embodiments

The objects of the present invention are also achieved by supplying a recording medium (or storage medium), which records a program code of a software program that can implement the functions of the above-mentioned embodiments to the system or apparatus, and reading out and executing the program code stored in the recording medium by a computer (or a CPU or MPU) of the system or apparatus. In this case, the program code itself read out from the recording medium implements the functions of the above-mentioned embodiments, and the recording medium which stores the program code constitutes the present invention.

The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the recording medium is written in a memory of the extension card or unit.

When the present invention is applied to the recording medium, that recording medium stores program codes corresponding to the aforementioned flowcharts.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-033728 filed on Feb. 10, 2004, which is hereby incorporated by reference herein.

1. An information processing method for generating an image by combining a virtual image and a physical space image, characterized by comprising:
a designation portion position acquisition step of acquiring a position of a designation portion operated by the user;
a user position/orientation acquisition step of acquiring a position and orientation of the user;
a detection step of detecting if the designation portion is located on a surface of a real object on a physical space;
a virtual index generation step of acquiring the position of the designation portion in response to the detection, and generating a virtual index on the basis of the position of the designation portion;
a virtual image generation step of generating an image of a virtual object corresponding to the real object from virtual space data on the basis of the position and orientation of the user; and
an adjustment step of adjusting the position and orientation of the virtual object in accordance with a user's instruction.

2. The method according to claim 1, characterized by further comprising a designation portion virtual index generation step of generating a designation portion virtual index at a tip portion of the designation portion on the basis of the position of the designation portion.

3. An information processing method for generating an image by combine a virtual image and a physical space image, characterized by comprising:
a designation portion position acquisition step of acquiring a position of a designation portion operated by the user;
a user position/orientation acquisition step of acquiring a position and orientation of the user;
a detection step of detecting if the designation portion is located on a surface of a real object on a physical space;
an adjustment step of acquiring the position of the designation portion in response to the detection, and adjusting a position and orientation of the virtual object on the basis of the position of the designation portion; and
a virtual image generation step of generating an image of a virtual object corresponding to the real object from virtual space data on the basis of the adjusted position/orientation and the position/orientation of the user.

4. The method according to claim 3, characterized in that the adjustment step includes a step of adjusting the position and orientation of the virtual object along a straight line having the orientation of the designation portion as a direction vector.

5. The method according to claim 3, characterized in that the adjustment step includes steps of:
selecting a surface which forms the virtual object on the basis of the position of the designation portion; and
adjusting the position and orientation of the virtual object in a normal direction of the surface.

6. The method according to claim 3, characterized in that the adjustment step includes a step of rotating the position and orientation of the virtual object using a specific point as a fulcrum or a line segment that connects two specific points as an axis.

7. The method according to claim 3, characterized in that the adjustment step includes a step of adjusting the position and orientation of the virtual object on the basis of positions of a plurality of feature points which are set in advance on the real object.

8. A program characterized by making a computer execute an information processing method of claim 1.

9. A program characterized by making a computer execute an information processing method of claim 3.

10. An information processing apparatus for generating an image by combining a virtual image and a physical space image, characterized by comprising:
designation portion position acquisition unit configure to acquire a position of a designation portion operated by the user;
user position/orientation acquisition unit configure to acquire a position and orientation of the user;
detection unit configure to detect if the designation portion is located on a surface of a real object on a virtual space;
virtual index generation unit configure to acquire the position of the designation portion in response to the detection, and generating a virtual index on the basis of the position of the designation portion;
virtual image generation unit configure to generate an image of a virtual object corresponding to a real object from virtual space data on the basis of the position and orientation of the user; and
adjustment unit configure to adjust the position and orientation of the virtual object in accordance with a user's instruction.

11. An information processing apparatus for generating an image by combining a virtual image and a physical space image, characterized by comprising:
designation portion position acquisition unit configure to acquire a position of a designation portion operated by the user;
user position/orientation acquisition unit configure to acquire a position and orientation of the user;
detection unit configure to detect if the designation portion is located on a surface of a real object on a physical space;
adjustment unit configure to acquire the position of the designation portion in response to the detection, and adjusting a position and orientation of a virtual object on the basis of the position of the designation portion; and
virtual image generation unit configure to generate an image of a virtual object corresponding to a real object from virtual space data on the basis of the adjusted position and orientation and the position and orientation of the user.
